(19) United States
(12) Patent Application Publication
(10) Pub. No.: US 2010/0132735 A1
(43) Pub. Date: Jun. 3, 2010

(54) CLEANING APPLIANCE WITH SYSTEM FOR GERM REDUCTION USING MICROWAVES

(76) Inventors: Bruno Gaus, Offenburg (DE); Thomas Naeger, Offenberg (DE); Thomas Peukert, Oberkirch (DE); Stenfan Scheringer, Offenburg (DE); Ingo Wiegand, Buehlertal (DE)

Correspondence Address: Muncy, Geissler, Olds & Lowe, PLLC, 4000 Legato Road, Suite 310, FAIRFAX, VA, 22033, US

(21) Appl. No.: 12/627,650

(22) Filed: Nov. 30, 2009

Related U.S. Application Data
(63) Continuation of application No. PCT/EP2008/002527, filed on Mar. 31, 2008.

(30) Foreign Application Priority Data
May 30, 2007 (DE) 10 2007 025 263.5

(51) Int. Cl. B08B 3/00; B08B 7/00

(52) U.S. Cl. 134/1; 134/115 R

(57) ABSTRACT

A cleaning appliance for cleaning objects to be cleaned is provided. The cleaning appliance comprises a cleaning region for cleaning the object to be cleaned using a cleaning liquid. The cleaning appliance also comprises a microwave disinfecting device having a microwave source for generating microwave radiation. The microwave disinfecting device is used to sanitize objects, which are received in the cleaning appliance in order to be cleaned.

This nonprovisional application is a continuation of International Application No. PCT/EP2008/002527, which was filed on Mar. 31, 2008, and which claims priority to German Patent Application No. DE 10 2007 025 263.5, which was filed in Germany on May 30, 2007, and which are both herein incorporated by reference.

### BACKGROUND OF THE INVENTION

1. Field of the Invention

The invention relates to a cleaning appliance for the cleaning of cleaning stock, said appliance having at least one microwave disinfection apparatus. Cleaning appliances of this type are used, for example, in the commercial sector or in the domestic sector in the form of dishwashers or in the hospital or care sector in the form of automatic cleaning and disinfection machines or basin washers. Furthermore, the invention relates to a steam generator for use in a cleaning appliance and to a method for the cleaning of cleaning stock in a cleaning appliance.

2. Description of the Background Art

Cleaning appliances for the cleaning of cleaning stock or washing stock are known in numerous different variations from the prior art. The configuration of these cleaning appliances depends on various boundary conditions, such as the type of washing stock to be cleaned, the dirt, the throughput or similar conditions.

The invention described below is applicable to numerous cleaning appliances for cleaning the most diverse possible types of cleaning stock. A first special focus is in the field of dishwashers. Dishwashers of this type are known as domestic appliances and as commercial dishwashers for use, for example, in staff canteens, hospitals, schools or similar establishments with large kitchens. Commercial dishwashers are subdivided into continuous-flow dishwashers, in which the cleaning stock to be washed (for example, cups, plates, cutlery, glasses, trays or similar washing stock) runs in succession through a plurality of cleaning zones. For example, a continuous-flow dishwasher of this type may have a preclearing zone, a washing zone, a rinsing zone and a drying zone. Dishwashers with fewer cleaning zones are also known. Continuous-flow dishwashers are configured in the prior art, for example, as belt transport or basket transport machines.

By contrast, single-chamber dishwashers usually have a single washing chamber as a cleaning zone, in which, once again, cleaning stock, for example in the form of cups, plates, glasses, cutlery, crockery or trays, can be cleaned. Normally, single-chamber dishwashers for the domestic sector are operated with a change of water, that is to say one and the same tank is normally used for a washing program and a rinsing step, an exchange of the water or of the cleaning fluid taking place in the tank between these steps. In order to increase the throughput, single-chamber dishwashers are employed for commercial use which have, in addition to a washing tank, a rinsing tank, for example a boiler. In this rinsing tank, rinsing fluid (for example, water with added rinse agent) is heated to a rinsing temperature, while the actual washing operation is proceeding in the washing chamber.

A further focus of the present application is cleaning appliances which are suitable for the cleaning of medical instruments and/or care instruments. These may be, in particular, cleaning stock in which large quantities of liquid waste and/or solid waste occur which have to be disposed of. Mention may be made in this context, as examples, of chamber pots, basins, bedpans, urine bottles or similar vessels, in which liquid quantities of more than a few 10 ml up to the liter range may easily occur. Cleaning appliances of this type are designated below, without the cleaning stock being restricted to a specific care instrument, as “basin washers”.

Both in dishwashers and especially in basin washers, and also in other types of cleaning appliances, a hygienic action in the cleaning may in many instances play a special part. Thus, where dishwashers are concerned, it is necessary to ensure that all types of cleaning stock or washing stock which come directly or indirectly into contact with foods or drinks have adhering dirt reliably removed from them. A more serious problem arises in basin washers in which adhering germs (viruses or bacteria) may entail an increased risk of infection. To that extent, in many instances, a hygienization of the cleaning stock is required. This hygienization may range from simple germ reduction via disinfection (for example, disinfection by chemical disinfectants and/or thermal disinfection by steam or another type of heat action) up to a complete sterilization of the cleaning stock. The term “disinfection” is predominantly used below in general and without the scope of protection of the invention being restricted, and this term is in general to involve simple germ reduction, but is also to extend up to virtually complete germ destruction and sterilization of cleaning stock.

To judge the hygienization which has been reached in the cleaning stock in cleaning appliances, test methods are usually adopted which are based on the germ reduction of specific test germs on the cleaning stock surface. Standards for various types of cleaning appliances to which the present invention is applicable are also in existence for this purpose.

Thus, in Germany, for example, DIN 10511-12 C.3 exists for dishwashers. This standard describes a method in which, by means of glasses soiled in a defined way, germ reduction after the program sequence is determined via what are known as dabbing tests. In this case, a minimum germ reduction must be achieved in the shortest or unfavorable washing program. The test germ or organism used in this test is E. faecium ATCC 6057. The results of this investigation then give minimum requirements as to temperature, washing duration, detergent concentration and mechanical washing powers, with which this cleaning appliance then has to be preset at the factory, in order to achieve the required germ reduction when it is in operation on the customer's premises.

A method is known from the USA which is used predominantly for dishwashers and is described in NSF standard 3. This method is based on the germ reduction, determined from tests, of tuberculosis bacteria by the action of temperature over time. The action of temperature over time is designated as the “heat equivalent” (HUE). How many heat equivalents per second are achieved at which temperature is recorded in a table on which this method is based. By means of tests, for dishwashers, a minimum tank temperature and a minimum rinsing temperature have been defined which the dishwasher must reach in order to achieve the required germ reduction. For the dishwasher manufacturer, this means that these temperatures have to be permanently preset in the washer control of the dishwasher at the factory.

In checking the process taking place in a dishwasher by this NSF-3 method, a temperature sensor is attached to a plate. Subsequently, this plate is placed in a predetermined position in the crockery basket of the dishwasher, and the temperature is recorded during the program sequence. Then, by means of the abovementioned table, the heat equivalents acting on the plate over the entire program sequence are determined from the temperature profile during the entire washing program. This test is prescribed for three different plate positions inside the crockery basket. To fulfill the required germ reduction, according to regulation NSF-3 at least 3600 heat equivalents must be achieved in each plate position inside the crockery basket. The advantage of this method is that it can be carried out with little effort on site at the customer's premises, in order to check that the dishwasher is functioning satisfactorily.

In the European region, EN ISO 15883-1 applies to cleaning/disinfection appliances, such as, for example, basin washers, and likewise employs the relationship between germ reduction and temperature over time in order to judge the hygienic action. This relationship is designated as the A₀ value and is likewise recorded in a table or is calculated according to a mathematical relation. The A₀ value is defined as the time equivalent in seconds at a temperature of 80° C., in which a given disinfection action is exerted, and accordingly corresponds to the heat equivalents (HUE) according to NSF standard 3. In this case, too, a minimum A₀ value which must be reached must be ensured at each point in the washing chamber of the cleaning and disinfection appliance and of the cleaning stock. This therefore also refers to the most unfavorable point in the most unfavorable program. This method is not employed at the present time in order to judge the hygienic action of commercial dishwashers in the European area.

All the methods outlined above have in common the fact that the most unfavorable washing program or the most unfavorable conditions are always employed in order to judge the germ reduction. The disadvantage of this procedure, however, is that, owing to the rigid stipulations for the washing programs, which differ from these stipulations in terms of temperature or further program parameters, unnecessarily long program running times sometimes occur, this being highly undesirable. Thus, for example, while germ reduction remains the same, the program running time could be shortened by increasing the washing and/or rinsing temperature.

Furthermore, it should be noted that the known methods for germ reduction and the corresponding standards have the disadvantage that, as a rule, they entail enormous energy consumption. Particularly in the field of commercial dishwashers and with regard to cleaning according to hospital and care requirements, however, this disadvantage becomes more serious. Thus, thermal disinfection may amount to a high percentage of the overall energy consumption of the cleaning appliance. Alternatively or additionally, depending on the degrees of contamination, chemical disinfection or germ reduction methods are also adopted, but these may entail considerable environmental pollution and, likewise, greatly increased costs for the cleaning process on account of the aggressiveness of the chemicals used.

### SUMMARY OF THE INVENTION

It is therefore an object of the invention to provide a cleaning appliance which at least largely avoids the above-presented disadvantages of known cleaning appliances. In particular, the cleaning appliance is to allow energy-saving, cost-effective and environmentally friendly germ reduction in the cleaning stock.

According to an embodiment of the invention, a cleaning appliance for the cleaning of cleaning stock is provided, which has at least one cleaning zone for cleaning the cleaning stock with a cleaning fluid. For example, the cleaning appliance may correspond to a known cleaning appliance according to the above description of the prior art and may, for example, comprise a continuous-flow dishwasher, a single-chamber dishwasher (particularly for commercial use) and/or a basin washer.

An aspect of the present invention is to avoid or to reduce the problem of hitherto known chemical and/or thermal germ reductions in conventional cleaning appliances by using microwave radiation for hygienization. Microwave radiation is in this context understood below to mean electromagnetic radiation which lies in a frequency range of between 0.3 and 300 GHz. This microwave radiation can be used directly (that is to say, by the direct irradiation of the stock to be hygienized) and/or indirectly for the hygienization of the cleaning stock. In this context, “indirect” hygienization is to be understood as meaning hygienization in which the microwaves are utilized in order not to kill germs directly but, instead, to bring about a heating of a further article, this heating, in turn, giving rise to the germ-reducing action. For example, this third article may be the cleaning stock itself which is to be cleaned (for example, crockery, cups, glasses, cutlery, trays, bedpans, urine bottles, basins, chamber pots or the like), a liquid film which is received on this cleaning stock, water which then, in turn, is applied to the cleaning stock for germ reduction, steam or the like.

It may in this case be pointed out that, in contrast to conventional terms, the terms “hygienization”, “disinfection”, “germ reduction” and “sterilization” are used synonymously, without the degree of hygienization thereby being expressed. Hygienization may range from simple germ reduction (for example, a reduction in contamination by one or more pathogens or germs, for example bacteria or viruses) by a few percent (for example, 10%) up to virtually complete germ destruction (sterilization). It is preferable if hygienization is carried out in such a way that more than 90% of the germs are killed.

The use of microwave radiation is known from the conventional art from various other sectors. For example, microwave radiation is employed on a large scale for the drying of masonry in the construction sector. Other fields of use are, for example, lacquer production and coating technology in which microwave methods are employed in order to dry the coatings (see, for example, EP 1 327 844 A2). The fundamental idea of the present invention, however, is not, or not exclusively, to use microwave radiation for drying, but, instead, to employ it in a directed manner for germ reduction in cleaning appliances.

Accordingly, it is proposed to equip the cleaning appliance with a corresponding microwave disinfection apparatus. This microwave disinfection apparatus (a plurality of such apparatuses may also be provided) is to have a microwave source for generating the microwave radiation. For example, this microwave source may comprise conventional known types of microwave generators, the use of magnetrons being preferred because the properties of the radiation generated can be set in a directed manner. Alternatively or additionally, however, other types of microwave sources may also be employed.

As described above, the microwave disinfection apparatus is to be set up in order to bring about direct or indirect germ reduction. This may take place, for example, in that, as indicated above, one or more of the following functional principles can be adopted as outlined below.

By means of microwave radiation, steam is generated in a steam generator of the microwave disinfection apparatus, which steam is used in order to carry out germ reduction (indirect hygienization).

The microwave radiation is aligned with the cleaning stock, the microwave radiation being set up in order to heat a liquid film which is still located on the surface of the cleaning stock from the preceding cleaning operations. This heating preferably takes place up to a temperature such that germs located on the surfaces of the cleaning stock are essentially killed. The temperature on the surface of the cleaning stock may be monitored, for example, by means of one or more temperature sensors. This heating of a liquid film on the surface of the cleaning stock is, once again, indirect hygienization.

The microwave radiation is aligned with the cleaning stock, the microwave radiation being set up in order to heat the cleaning stock. This heating preferably takes place up to a temperature such that germs are essentially killed. For example, the temperature of the cleaning stock may be monitored by means of one or more temperature sensors. The microwave radiation is preferably selected in terms of its frequency range in such a way that it is at least partially absorbed by the cleaning stock. This is possible comparatively simply, since, particularly in the commercial sector, usually only a few, mostly known types of cleaning stock are cleaned in the cleaning appliance (for example, plates), in which case the absorption of the materials used there may be known. This heating of the cleaning stock is, once again, indirect hygienization.

The microwave radiation is aligned with the cleaning stock, the microwave radiation being set up in order to reduce germs on and/or in the cleaning stock and/or also in the entire cleaning appliance (for example, a chamber of the cleaning appliance). This hygienization is direct hygienization, the microwave radiation preferably being set in terms of its frequency in such a way that it is set directly to absorption properties of the germs. In particular, known bacteria and/or viruses are to absorb this microwave radiation at least partially. This hygienization is direct hygienization.

The microwave disinfection apparatus has a steam generator, the cleaning appliance being set up in order to subject the cleaning stock to steam generated by the steam generator. In contrast to the abovementioned first hygienization principle, however, the steam generator may comprise “conventional” steam generation (for example, by means of heating). However, the microwave disinfection apparatus is set up in order to superheat the steam by means of microwave radiation. This principle makes it possible, by the steam at least partially absorbing the microwave radiation, to superheat this steam within the cleaning appliance, without increased pressures thereby being required. Thus, for example even under normal pressure or only slight overpressure or even under negative pressure, the steam can be heated to above 100° C. in the cleaning appliance, with the result that germ reduction is greatly improved.

The proposed microwave hygienization has numerous decisive advantages, as compared with conventional hygienization methods. Thus, for example, the cleaning stock can be acted upon specifically to the germs occurring, the microwave radiation being set, for example, directly to a target germ or target pathogen to be killed or to a group of such pathogens or germs. The efficiency of germ reduction is thereby considerably increased.

Furthermore, an unspecific overall heating of the cleaning chamber or of the cleaning zone is not required or is required to only a substantially lesser extent, in contrast to known thermal hygienization methods. The microwave radiation can, for example, be radiated onto the cleaning stock in a directed manner, so that the power density or energy density can be increased in a directed manner solely in the region of this cleaning stock. A considerable saving of energy can thereby be brought about.

Even in steam generation for germ reduction, considerable quantities of energy can be saved. Accordingly, independently of the cleaning appliance, a steam generator is also claimed, which is based on the principle of steam generation by means of a microwave source and which is suitable for use in a cleaning appliance. In contrast to steam generators which are known from the prior art and usually employ heating in a tank for steam generation, this microwave steam generator manages with the smallest possible liquid quantities to be evaporated. Whereas, in thermal steam generators, there is, for example, a problem that a heating coil has to be covered completely, with the result that a minimum water quantity is predetermined, steam generators according to this novel principle can be operated even with only a few milliliters of water or of another liquid, and therefore, in turn, steam generation efficiency can be greatly improved.

Notwithstanding, however, even conventional hygienization methods, for example thermal and/or chemical hygienization methods, can be combined with the proposed microwave hygienization method. Due to the use of microwaves, however, the outlay, for example the outlay in terms of energy and/or the quantity of a chemical disinfectant added, can be diminished considerably, and the dimensioning of, for example, heating sources for thermal disinfection can be reduced.

The microwave disinfection apparatus may have at least one waveguide for orienting the microwave radiation. The waveguide may be used, in particular, for conducting the microwaves from the microwave source to a housing, for example an inner space of the cleaning zone (for example, an inner space of a washing chamber). In particular, the at least one waveguide may also be used for aligning the microwaves with the cleaning stock, for example in that this waveguide has an orifice correspondingly aligned with the cleaning stock. An orifice of the waveguide inside the cleaning zone may have a closable orifice, for example an opening flap. In particular, this opening flap may be configured in such a way that it prevents cleaning fluid from penetrating into the waveguide and/or into the microwave source. For example, the opening flap may have a spring-mounted opening flap which is opened automatically by means of a blower of the microwave disinfection apparatus. A valve to be opened automatically (for example, electromechanically) may also be provided at the orifice. The term “closable”, however, is also to be understood as meaning another way of screening off the orifice, for example a cover which is at least partially transparent to microwaves, but which repels water from the interior of the waveguide.

The microwave disinfection apparatus may be set up, furthermore, in order to apply hot air to the cleaning appliance. For example, the above-described waveguide may be used in order to conduct hot air to the cleaning stock. It is in this case particularly preferable if the microwave disinfection apparatus has a blower which is used for generating the hot air. A microwave source itself may be used for this generation of the hot air, since, as a rule, it produces waste heat. For example, a cooling blower of the microwave disinfection apparatus may be used, which first conducts air to the microwave source, the air being heated there, in order subsequently to apply this air to the cleaning stock. Thus, for example, a drying effect of damp washing stock can be achieved and/or the hygienization effect of the microwave radiation can be assisted by hot air, without a separate blower with a device for heating the air being required for this purpose. Considerable energy can thereby be saved.

The microwave source may be operated in the continuous wave mode or in the pulsed mode. In this case, the microwave disinfection apparatus may be set up in order to generate microwave radiation with a single frequency or within a single frequency band. Alternatively or additionally, the microwave disinfection apparatus may also be set up in order to generate microwave radiation with at least two frequencies. For example, microwave radiation may be generated which is absorbed particularly well by the cleaning stock, and microwave radiation may be generated which has an immediate disinfection effect on germs on the cleaning stock. It is in this case particularly preferable if the microwave radiation is selected in such a way that it is not absorbed or is absorbed only insignificantly by the materials of the cleaning appliance, for example by chamber walls of a cleaning zone and/or of a washing chamber. This is easily possible nowadays with modern microwave sources, for example the above-described magnetron. Moreover, cleaning appliances may also be designed correspondingly with suitable materials which are, for example, completely or partially transparent (that is to say, non-absorbent or only insignificantly absorbent) to the microwave radiation used, that is to say do not appreciably heat up.

The microwave disinfection apparatus may be set up, in particular, in such a way that microwave radiation with at least one frequency is emitted which is absorbed at least partially by the cleaning stock. Alternatively or additionally, microwave radiation may be generated which is absorbed by cleaning fluid adhering to the cleaning stock. Again alternatively or additionally, microwave radiation may also be emitted which is absorbed at least partially by germs, in particular by germs adhering to the cleaning stock. Also alternatively or additionally, microwave radiation may be used which has at least one frequency and which is absorbed at least partially by the steam contained in the cleaning appliance. Here, for example, the frequency band of approximately 2.5 GHz used in conventional microwave appliances is appropriate.

In addition to the radiation of one or more permanently predetermined frequencies or frequency bands, the microwave disinfection apparatus may also be set up in such a way that one or more frequency bands are varied in time. Thus, the frequency band or frequency bands may successively cover different frequency ranges in that the microwave radiation is variably tuned. Thus, for a short time, a higher spectral energy density can be generated, which, however, is then variably tuned over a specific range. The disinfection efficiency can thereby be additionally increased.

As described above, it is preferable that the cleaning appliance has at least one temperature sensor. In particular, this at least one temperature sensor may be used in order to detect a temperature of the cleaning stock. Alternatively or additionally, however, this at least one temperature sensor may also detect, for example, an ambient temperature (for example, a steam temperature) in the at least one cleaning zone and/or in a separate disinfection zone. For example, the sensors used may be infrared sensors. Alternatively or additionally, however, other types of temperature sensors, for example resistive temperature sensors, may also be employed.

An embodiment of the cleaning appliance is particularly advantageous in which the latter is set up in order to enable a user to input at least one target germ and/or one group of target germs. This input may take place, for example, manually, for example via a keyboard, a visual display unit (for example, by selection from a list) or other manual input devices. Alternatively, however, input may also take place by means of data exchange, for example via an interface, for example within the framework of incorporating the cleaning appliance into a network in a hospital and/or nursing home. Thus, for example, all the cleaning appliances or some cleaning appliances within a hospital or a nursing home can be set simultaneously or with a slight time offset to pathogens which have become known. For example, a doctor or a nurse can, from a central terminal, inform several cleaning appliances that an increased occurrence of a specific target germs or target pathogen or of a group of such target germ or target pathogens is to be expected. This information can be obtained, for example, from patient databases or from public information, for example within the framework of an epidemic information network. When specific epidemics or infections occur or when there is an increased probability of the occurrence of such epidemics or infections, the cleaning appliances can then be set centrally in a directed manner in order to achieve particularly high hygienization efficiency amounting to a disinfection or sterilization of the cleaning appliance specially for the selected target germ or the selected target germs.

This information on the target germ or on the group of target germs makes it possible to activate the microwave disinfection apparatus according to the selection of the target germ or target germs. For example, a target germ-specific frequency or a target germ-specific frequency band can be set in a directed manner. Alternatively or additionally, a target germ-specific action time of disinfection, for example of one of the above-described direct or indirect disinfection methods, may also be selected. For example, this may be the action time of direct microwave disinfection, that is to say of direct germ killing by microwaves, or, alternatively or additionally, an action time of steam disinfection, the steam being generated by microwaves and/or being superheated by microwaves. If the microwaves are used in order to bring about thermal disinfection (for example, by steam), then, for example, the above-described hygienization standards can be used once again so that a reliable germ kill can be estimated. Alternatively or additionally, however, appliance-specific experimental values may also be collected which may be stored, for example, in a list, in order then to use these experimental values for hygienization according to the input target germ or target germs. In this case, purely empirically obtained experimental values can be employed, or else analytically or semi-empirically obtained information can be used. Empirical experimental values of this type are easily obtainable experimentally, for example, by means of corresponding dabbing tests of test germs, via which, for example, the effect of microwave disinfection on a target germ population can easily be detected.

Furthermore, alternatively or additionally, a target germ-specific active dose can also be used, in which case, once again, experimental values or semi-empirical or analytic values may be employed, for example, according to the above-described method. An active dose is in this context to be understood as meaning a time integral against an intensity of the microwave radiation which impinges on the cleaning stock, in each case multiplied by an active factor which is dependent on the frequency or the frequency band of the microwave radiation used and on the type of target germ:

D=∫I(f)·R(f,K)·dt (1),

I(f) designating the intensity (impinging radiation power per unit area of the cleaning stock), R(f,K) designating an active factor which is dependent on the frequency used or the frequency band f and on the target pathogen or the target pathogens K. Integration in this case takes place over the entire action time of the microwave radiation.

This active dose or the individual components of this active dose can once again be determined, for example, empirically by dabbing tests according to irradiated samples contaminated with known test germs and be tabulated, for example, for various test germs. Thus, for example, the germ-killing action which influences the active factor R can be determined, and in each case the washing stock can be subjected to a corresponding active dose of microwave radiation according to the predetermined target germ or the predetermined target germs.

The cleaning appliance may comprise, for example, a control which is set up in order to control a program sequence. For example, in at least one program step of the program sequence, a germ reduction step can then be carried out in which the microwave disinfection apparatus is activated correspondingly.

As described above, the cleaning appliance may comprise, in particular, a continuous-flow dishwasher or may be a continuous-flow dishwasher of this type. The configuration or incorporation of a single-chamber dishwasher, particularly for the commercial sector (that is to say, preferably without a water change, i.e. having a separate rinsing tank), is also possible. Furthermore, alternatively or additionally, it is conceivable to incorporate a basin washer which is preferably designed for the cleaning of medical instruments and/or care instruments having copious liquid or solid waste. In particular, this basin washer may comprise a washing chamber, an outflow with a siphon bend, and, preferably, an exhaust air line which, bypassing the siphon bend, issues from the washing chamber into the outflow. Moist air can be pressed through this exhaust air line out of the washing chamber into the outflow, for example by means of a separate supply air blower which forcibly introduces fresh air into the washing chamber and displaces moist air into the outflow. Alternatively or additionally, however, a blower of the microwave disinfection apparatus may also be used for this displacement which may be used, for example, for cooling the cleaning stock. This blower is to be set up in order to displace moist air out of the washing chamber into the outflow. In both instances described, the exhaust air line may have, for example, a self-closing valve, in particular a nonreturn valve, which may be used, for example, in order to prevent recontamination of the cleaning stock in the washing chamber by air penetrating from the outflow.

In the event that the cleaning appliance is configured as a basin washer, but also in the case of other types of cleaning appliances with an outflow, it is particularly preferable if the microwave disinfection apparatus is set up in order to heat liquid received in the outflow. For example, liquid in the outflow can thereby be disinfected. Alternatively or additionally, this heating of the liquid in the outflow may, however, also extend to the outflow itself being used as a steam generator. For example, steam can be generated from the fluid received in the outflow in order to at least partially hygienize cleaning stock in the washing chamber by means of this steam.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a continuous-flow dishwasher according to the invention;

FIG. 2 shows an exemplary embodiment of a single-chamber dishwasher according to the invention;

FIG. 3 shows an exemplary embodiment of a basin washer according to the invention; and

FIG. 4 shows an exemplary embodiment of a steam generator according to the invention.

### DETAILED DESCRIPTION

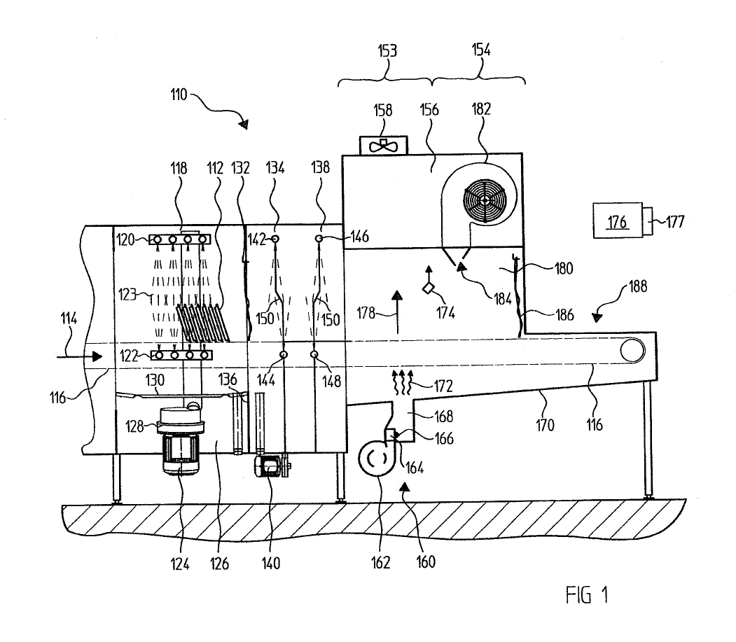

FIG. 1 shows a first exemplary embodiment of a cleaning appliance in a diagrammatic sectional illustration from the side. In this case, the cleaning appliance is configured as a continuous-flow dishwasher 110. In this continuous-flow dishwasher 110, cleaning stock 112 is transported in a flow direction 114 or transport direction through treatment zones or cleaning zones of the continuous-flow dishwasher 110. A conveying device 116, which is designed in the illustration according to FIG. 1 as an endless conveyor belt, transports the stock 112 to be cleaned through the various cleaning zones of the continuous-flow dishwasher 110.

As seen in the transport direction 114 of the stock 112 to be cleaned, the latter first passes through a washing zone 118. Inside the washing zone 118 are located a first washing system 120 and a second washing system 122. Cleaning fluid 123 emerges from these in jet form. The first washing system 120 and the second washing system 122 are subjected to cleaning fluid via a first pump 124. The first pump 124 is accommodated inside a washing zone tank 126 which is assigned to the washing zone 118. In the upper region of the first pump 124 is located a pump housing 128. The washing zone tank 126 is covered by means of a tank covering screen 130. The washing zone tank 126 assigned to the washing zone 118 contains a heated or unheated water supply.

The washing zone 118 is separated by means of a separating curtain 132 from the pump rinsing zone 134 which follows said washing zone, as seen in the transport direction 114 of the stock 112 to be cleaned. The washing zone tank 126 is separated via a partition 136 from the tank which is located beneath the pump rinsing zone 134 or a fresh water rinsing zone 138 following the pump rinsing zone 134.

In the illustration according to FIG. 1, the stock 112 to be cleaned, leaving the washing zone 118, runs into the pump rinsing zone 134 after passing through the separating curtain 132. The pump rinsing zone 134 is fed via a second pump 140. The cleaning fluid 123 emerging from a first spray pipe 142 and a second spray pipe 144 in the pump rinsing zone 134 wets the stock 112 to be cleaned from the top side and the underside. The spray pipes 142, 144 arranged in the pump rinsing zone 134 are received on a bent pipe, so that an offset of the first spray pipe 142 as compared to the second spray pipe 144 in the pump rinsing zone 134 is achieved.

The same applies to the fresh water rinsing zone 138 which may follow the pump rinsing zone 134. The fresh water rinsing zone 138 comprises an upper spray pipe 146 and a lower spray pipe 148. The two spray pipes 146, 148 are likewise arranged so as to be offset with respect to one another according to the spray pipe profile 150, as seen in the transport direction 114 of the stock 112 to be cleaned. The fresh water volume emerging from the upper spray pipe 146 and the lower spray pipe 148 wets the stock 112 to be cleaned from its top side and its underside with a fresh water jet 152.

The fresh water rinsing zone 138 is followed by a disinfection zone 153 and a drying zone 154. These zones 153, 154 may, for example, be separated from the fresh water rinsing zone 138 by means of a further curtain (not illustrated in FIG. 1).

In the exemplary embodiment illustrated in FIG. 1, which does not restrict the scope of the invention, a heat recovery device 156 is arranged in the disinfection zone 153. This heat recovery device 156 comprises an exhaust air blower 158, by means of which exhaust air is drawn off from the continuous-flow dishwasher 110. For example, the heat recovery device 156 may comprise a heat exchanger, via which heat exchanger liquid is heated so as subsequently to be used, for example, in the washing zone tank 126. Thus, the discharged heat is at least partially reused, so that the energy demand for heating the washing zone tank 126 can be lowered. Furthermore, the heat recovery device 156 may also comprise a condensate precipitation device (not illustrated) in order to at least partially condense moist air.

Furthermore, a microwave disinfection apparatus 160 is provided in the disinfection zone 153. In the exemplary embodiment illustrated in FIG. 1, in this case only one such microwave disinfection apparatus 160 is illustrated, although a plurality of such devices may, of course, also be provided, for example in order to subject the stock 112 to be cleaned to microwaves to from a plurality of sides. For example, a further microwave disinfection apparatus 160 may be arranged in the ceiling region of the disinfection zone, for example in order to subject plate surfaces to microwave radiation in a directed manner.

In this exemplary embodiment, the microwave disinfection apparatus 160 comprises a blower 162 which cools a magnetron 164. The dimensioning of the blower 162 in FIG. 1 is indicated merely diagrammatically. The magnetron 164 comprises an anode 166 as a transmitter antenna. This anode 166 projects into a waveguide 168 into which microwave radiation 172 generated in the magnetron 164 is fed. The waveguide 168 is dimensioned correspondingly and may, for example, have a square or rectangular cross section. In the exemplary embodiment in FIG. 1, the waveguide 168 has an essentially upwardly directed vertical profile and is coupled, beneath the conveying device 116, to a housing bottom 170 of the continuous-flow dishwasher 110. As described above, a plurality of microwave disinfection apparatuses 160 with a plurality of waveguides 168 of this type may also be provided, or else a plurality of waveguides 168 may be provided for one and the same microwave source.

The microwave disinfection apparatus 116 and the magnetron 164 are configured to generate microwave radiation 172 and to apply it via the waveguide 168 to the cleaning stock 112 when the latter is located in the region of the issue of the waveguide 168 into the disinfection zone 153. Sensors may be provided which detect whether cleaning stock 112 is located above this issue, so that, preferably, microwave radiation 172 is generated solely in this case. Alternatively or additionally, the anode 166 can also be utilized as a detector, in order to ascertain whether cleaning stock 112 is present, as is also proposed, for example, in EP 1327844 A2. Energy can thus be saved by avoiding unnecessary microwave radiation.

The microwave radiation 172 may be designed according to one of the exemplary embodiments described above, for example with a frequency in the region of 2.5 GHz, in order to heat water adhering to the cleaning stock 112 (indirect disinfection), in order to heat the cleaning stock 112 itself (indirect disinfection) and/or in order to kill directly germs adhering to the cleaning stock 112 (direct disinfection). Other disinfection principles of those described above may also be envisaged. A variation of the radiated frequency bands of the microwave radiation 172 over time is also conceivable. Furthermore, the conveying device 116 and, if appropriate, a basket or another receptacle for receiving the cleaning stock 112 may be configured so as to be essentially transparent to the radiated microwave radiation 172, for example by means of an appropriate choice of materials.

In the exemplary embodiment illustrated in FIG. 1, the issue of the waveguide 168 into the interior of the disinfection zone 153 is essentially open. Additionally, however, flaps, valves, bends, microwave-transparent coverings or other configurations may be provided, which, although allowing the cleaning stock 112 to be subjected to microwave radiation 172, nevertheless prevent water or other cleaning fluid dripping off from the cleaning stock 112 from passing through the waveguide 168 to the magnetron 164 and damaging the latter.

To check a temperature of the cleaning stock 112, a temperature sensor 174 may be provided in the region of the issue of the waveguide 168 into the drying zone 154. The signals from this temperature sensor 174 may be transmitted, for example, to a central control 176 which is indicated merely diagrammatically in FIG. 1 and which, for example, can activate the magnetron 164. From these temperature signals, the control 176 can derive, for example, heat equivalents to which the cleaning stock 112 is subjected and/or can control disinfection correspondingly. For example, the control 176 can control the microwave frequency, the microwave intensity, the belt speed (and, consequently, the action time), a pulse duration of microwave pulses or a combination of these parameters. Thus, by means of the control 176, the disinfection action of the microwave disinfection apparatus 160 can be controlled in a directed manner.

Furthermore, as described above, the control 176 may have an interface 177. For example, this interface 177 may be used in order to select or predetermine one or more target germs, with which disinfection is to be particularly coordinated. Reference may be made in this respect to the possibilities described above.

The blower 162 of the microwave disinfection apparatus 160 generates an air stream 178 directed upward in FIG. 1. Since the magnetron 164 generates heat which is absorbed by the air stream 178, this heated air stream 178 causes a first drying effect of the cleaning stock 112. The heated air stream 178 rises to the heat recovery device 156 where the heat of this air stream 178 is partially recovered.

The region 153, in which the heat recovery device 156 and the microwave disinfection apparatus 160 are received, is followed as a further optional part by a drying zone 154 with a blower zone 180. A drying blower 182 is received in this blower zone 180. Heated air emerging from the drying blower 182 is blown via outlet nozzles 184 onto the top side of the stock 112 to be cleaned. On account of the microwave radiation 172 and the above-described first drying effect of the microwave disinfection apparatus 160, however, the drying blower 182 may ideally be dispensed with completely, or this drying blower 182 may be reduced considerably in terms of its dimensioning. A considerable energy outlay can thereby be saved.

The drying zone 154 is screened off from a run-out section 188 by means of a further separating curtain 132. In the region of the run-out section 188 of the continuous-flow dishwasher 110 according to the illustration in FIG. 1, the dried and partially cooled, now cleaned stock 112 can be removed from the conveying device 116 designed as a conveyor belt.

It may be pointed out that another configuration of the zones of the continuous-flow dishwasher 110 than in the exemplary embodiment illustrated in FIG. 1 is also possible, in particular another arrangement of the zones or another number of zones. In particular, the microwave disinfection apparatus 160 may be arranged at other locations, for example may be integrated into another zone which at the same time serves another purpose. For example, the drying zone 154 and the disinfection zone 153 may be combined, or a microwave disinfection apparatus 160 may be provided in the washing zone 118 and/or in the pump rinsing zone 134 and/or in the fresh water rinsing zone 138. Microwave disinfection apparatuses 160 may also be employed at the transition between a plurality of zones. Combinations of the various disinfection principles described above may also be adopted. For example, a microwave disinfection apparatus 160 may be used in such a way that steam present in any case in many zones is superheated in a directed manner by microwave radiation 172, that is to say is heated at least locally to temperatures above 100° C., in order to bring about or to intensify a disinfection effect. For example, this may also take place in the disinfection zone 153. A separate steam generator, which would have to have a high power in the continuous-flow dishwasher 110 on account of the high air stream and of the large volume and could therefore scarcely be implemented in practice for energy reasons, may then be dispensed with, and steam disinfection may nevertheless be carried out.

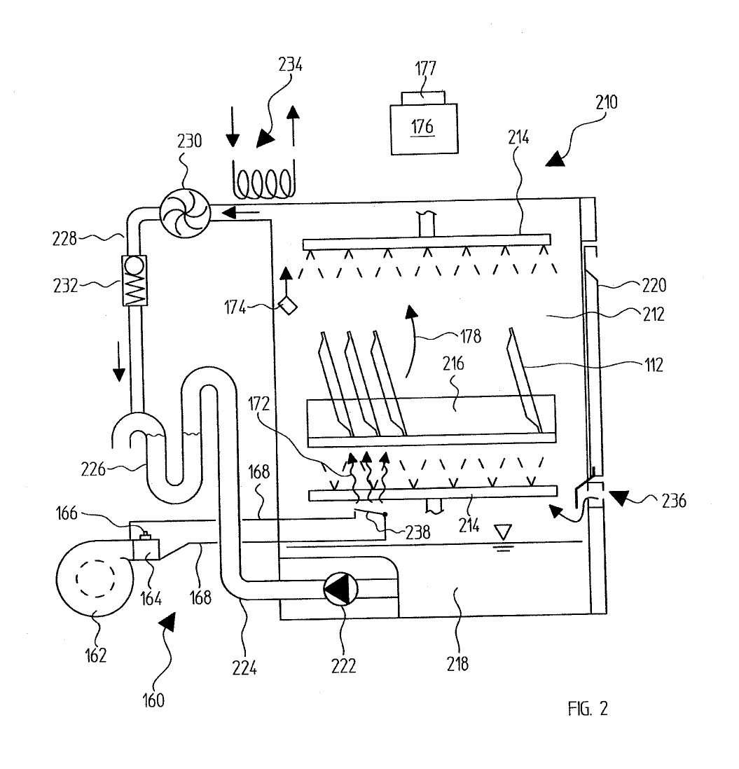

FIG. 2 illustrates a second exemplary embodiment of a cleaning appliance for the cleaning of cleaning stock 112. In this case, the cleaning appliance is a single-chamber dishwasher 210. The single-chamber dishwasher 210 comprises a washing chamber 212 with a spray nozzle system 214 received in it and with corresponding devices, not illustrated in FIG. 2, for the conveyance of cleaning fluid to this spray nozzle system 214. Thus, the cleaning stock 112, which is received in a corresponding basket 216, can be subjected to washing fluid from a tank 218 in the bottom region of the washing chamber 212.

The washing chamber 212 is accessible through a front flap 220 and can be loaded with cleaning stock 112. Waste water from the tank 218 can be pumped away into an outflow 224 via an outflow pump 222. The outflow 224 comprises a siphon bend 226 with a water supply, received in it, as a odor trap. The single-chamber dishwasher 210 has a hot air outlet 228 which, bypassing the siphon bend 226, connects the inner space of the washing chamber 212 to the outflow 224. In this exemplary embodiment, a blower 230 and a nonreturn valve 232 are received in the hot air outlet 228. Moreover, the hot air outlet 228 has a heat recovery device in the form of a heat exchanger 234 which is indicated merely symbolically in FIG. 2. By means of this heat exchanger 234, heat can be at least partially extracted from the hot exhaust air which is sucked out of the washing chamber 212. The heat exchanger liquid can subsequently be supplied, for example, to the tank 218 so that energy can be saved. Beneath the front flap 220 of the washing chamber 212, an air inlet 236 in the form of a gap is provided, by means of which pressure equalization in the washing chamber 212 can take place. Both this air inlet 236 and, for example, also the hot air outlet 228 are optional components. The single-chamber dishwasher according to the invention could also be implemented without these components.

Furthermore, according to the exemplary embodiment in FIG. 2, the single-chamber dishwasher 210 has a microwave disinfection apparatus 160. As in the exemplary embodiment in FIG. 1, too, this microwave disinfection apparatus 160 again comprises a blower 162, a microwave source (here, again, in the form of a magnetron 164) with a magnetron anode 166 and a waveguide 168 leading into the interior of the washing chamber 212. Once again, the microwave disinfection apparatus 160 is illustrated merely diagrammatically in FIG. 2 and may, for example, also comprise a plurality of microwave sources and a plurality of waveguides 168.

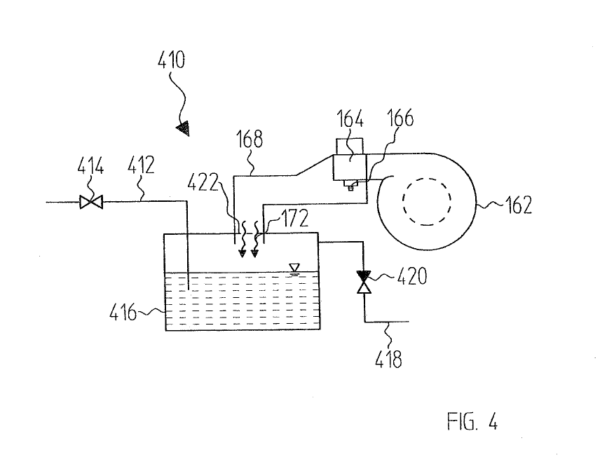

Once again, the microwave disinfection apparatus 160 can bring about a disinfection effect according to one or more of the disinfection principles described above. In particular, a plurality of microwave disinfection apparatuses 160 may also be implemented again, for example in order to irradiate the cleaning stock 112 from a plurality of sides. A direct or indirect disinfection effect can again be used, that is to say direct germ killing by the microwave radiation 172 and/or indirect germ killing by heating the cleaning stock 112, by the heating of detergent fluid, by the superheating of steam (that is to say, steam which is in any case present in the washing chamber 212 and/or is generated separately and/or is generated by microwave radiation) by microwave irradiation, by steam generation with microwave radiation in a separate steam generator (see also FIG. 4 below) or by any desired combination of these principles.

In the exemplary embodiment illustrated in FIG. 2 of the single-chamber dishwasher 210, the microwave disinfection apparatus 160 is preferably configured in such a way that it generates an upwardly directed air stream 178 via its blower 162. This air stream 178 assists the drying of the cleaning stock 112 after a cleaning of the cleaning stock 112 with cleaning fluid has been carried out. The air stream can subsequently be sucked away into the outflow 224 via the blower 230. On account of the air inlet through the blower 162 of the microwave disinfection apparatus 160, the air inlet gap 236 may optionally be dispensed with if the two blowers 162 and 230 are correspondingly adapted to one another.

The waveguide 168 of the microwave disinfection apparatus 160 has an upwardly directed bend at its end projecting into the washing chamber 212. The waveguide 168 is preferably configured in such a way that cleaning fluid cannot pass through the waveguide 168 to the magnetron 164. For this purpose, the waveguide 168 may have, for example in the region of the bend, corresponding slots or other orifices as an outflow. Additionally or alternatively, in this, as in the other exemplary embodiments, the waveguide 168 may have a valve at its end or inside it. This valve is illustrated symbolically in FIG. 2 in the form of a flap 238. The air stream generated by the blower 162 may be sufficient to open this flap 238 so that microwave radiation 172 can pass, unimpeded, onto the cleaning stock 112. Other forms of fluid repulsion (for example, water-repellant surfaces transparent to microwaves) may be envisaged, as already described above.

Once again, in the exemplary embodiment illustrated in FIG. 2, the single-chamber dishwasher 210 has, inside the washing chamber 212, a temperature sensor 174, by means of which, for example, the microwave disinfection and/or a drying, for example a “conventional” drying by hot air, and/or a microwave drying (that is to say, evaporation of the adhering water from the cleaning stock 112 by microwave irradiation) can be monitored. Once again, a control 176 is provided, which, for example, can be subjected to signals from the temperature sensor 174 and can control the program sequence. For example, the single-chamber dishwasher 210 illustrated in FIG. 2 or another exemplary embodiment of a single-chamber dishwasher can carry out a program/cleaning method in which at least one cleaning step with a cleaning fluid (for example, a washing program step and/or a rinsing step) is provided, followed by a disinfection step and an optional drying step. Furthermore, as described above, the control 176 may have an interface 177. For example, this interface 177 may be used in order to select or predetermine one or more target germs with which disinfection is to be particularly coordinated. Reference may be made, in this respect, to the possibilities described above.

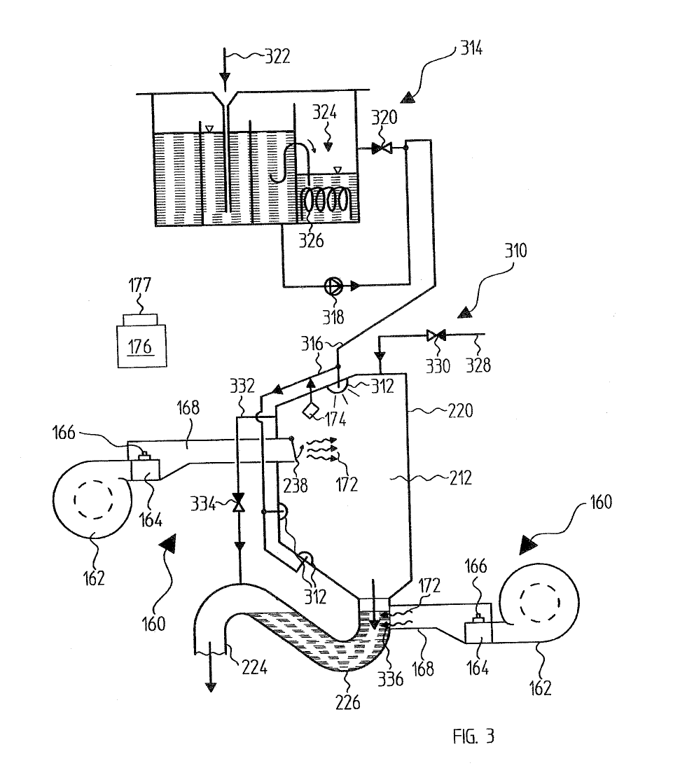

FIG. 3 illustrates a third exemplary embodiment of a cleaning appliance according to the present invention. In this exemplary embodiment, the cleaning appliance does not comprise a dishwasher, but, instead, a basin washer 310. For details of a possible configuration of this basin washer 310, reference may largely be made, as an example, to the configuration described in DE 10348344 A1.

The basin washer 310 comprises a washing chamber 212 with a front flap 220. By means of a holding device, cleaning stock 112 (the holding device and the cleaning stock are not illustrated in FIG. 3) to be received in the washing chamber 212. For example, the basin washer 310 may be configured in such a way that, when the front flap 220 is closed, the washing stock is emptied automatically. Thus, liquid or solid waste from the washing stock can be emptied into an outflow 224 of the basin washer 310. This ensures that the basin washer 310 is suitable for the cleaning of cleaning stock 112 having an incidence of copious liquid quantities. The basin washer 310 thereby differs, for example, from autoclaves which are used for the sterilization of medical instruments. However, the microwave disinfection according to the invention can also be employed in an autoclave as a cleaning appliance.

In the washing chamber 212, the washing stock can be subjected to cleaning fluid from a water/steam unit 314 via a system of nozzles 312. This water/steam unit 314 is connected via a pipeline system 316 to the nozzles 312 (which nozzles 312 may be simple orifices and/or even spraying nozzles of more complex configuration). Furthermore, a pump 318 and a nonreturn valve 320 are received in the pipeline system 316. The water/steam unit 314 is fed with fresh water via a fresh water inflow 322. Furthermore, the water/steam unit 314 comprises, in this exemplary embodiment, an optional “conventional” steam generator 324 with heating 326, so that the cleaning stock inside the washing chamber 212 can be subjected to steam by the pipeline system 316 and the nozzles 312. Thus, for example after an emptying of the cleaning stock 112, a customary cleaning operation may provide cleaning with cleaning fluid (for example, hot and/or cold water, if appropriate in each case with additives) which follows a steam disinfection step. For details of this operation, reference may be made once again, for example, to DE 10348344 A1 described above.

Alternatively or additionally, a microwave steam generator may also be employed in order to disinfect cleaning stock 112 in the washing chamber 212 of the basin washer 310. An exemplary embodiment of a microwave steam generator 410 of this type, which may be used in the exemplary embodiment, illustrated in FIG. 3, of a cleaning appliance and also in other types of cleaning appliances, is illustrated in FIG. 4. The microwave steam generator 410 comprises a fresh water inflow 412 with an optional fresh water valve 414. The fresh water inflow 412 is set up in order to supply fresh water to an evaporation chamber 416. The evaporation chamber 416 may receive, for example, a level sensor, in order to prevent overfilling of the evaporation chamber 416.

Furthermore, the microwave steam generator 410 has a steam outlet 418 which in this exemplary embodiment is equipped with a nonreturn valve 420.

Furthermore, the microwave steam generator 410 has a microwave source which in this exemplary embodiment is designed once again as a magnetron 164 and which has a blower 162 and a waveguide 168. In this (unrestrictive) exemplary embodiment, the waveguide 168 is configured as a bent waveguide 168 and issues into the evaporation chamber 416. At the issue, once again, caps, valves or other types of closures may be provided, in order to prevent moisture (for example, water or steam) from entering the region of the magnetron 164. In the exemplary embodiment illustrated in FIG. 4, for example, a cap 422 which is transparent to microwaves is illustrated. Furthermore, however, in the exemplary embodiment illustrated in FIG. 4, an air stream coming from the blower 162 and conducted into the evaporation chamber 416 also largely prevents steam from reaching the magnetron 164.

Moreover, the air stream or overpressure generated by the blower 162 may be utilized in order to displace steam generated by the microwaves 172 through the steam outlet 418. The overpressure in the evaporation chamber 416 is thereby increased. However, this steam displacement may also take place by means of the steam pressure alone.

The steam generator 410 illustrated in FIG. 4 may be used alternatively or additionally to the “conventional” steam generator 324 of the water/steam unit 314 in FIG. 3. For example, the microwave steam generator 410 could also be used instead of the steam generator 324. A corresponding modification of the water/steam unit 314 is easily possible for a person skilled in the art. The microwave steam generator 410 according to the exemplary embodiment in FIG. 4 affords the possibility, as compared with the “conventional” steam generator 324, that even small water quantities can be evaporated, while, in particular, there would, as a rule, be no need for a minimum filling quantity of the evaporation chamber 416 (for example, in order to cover a heating 326). Steam can thereby be generated efficiently, and this, in turn, may lead to an energy saving.

The steam generated by the “conventional” steam generator 324 and/or the microwave steam generator 410 may be used in a steam sterilization step in the basin washer 310 according to FIG. 3. In addition, this steam may be superheated by the microwave disinfection apparatus 160 according to FIG. 3 within the washing chamber 212, in order to additionally increase the steam disinfection efficiency.

Furthermore, according to the exemplary embodiment illustrated in FIG. 3, the basin washer 310 comprises a supply line 328 with a nonreturn valve 330, said supply line issuing in the washing chamber 212. The supply line 328 may be connected, for example, to a fresh air blower (not illustrated) and may be used in order, after a steam disinfection step, to displace steam into the outflow 224 via an exhaust air line 332, bypassing the siphon bend 226. Once again, a self-closing valve in the form of a nonreturn valve 334 is received in the exhaust air line 232. Thus, after the steam disinfection step has been carried out, the cleaning stock can be cooled and even partially dried by supply air, and the steam can be displaced at least partially out of the washing chamber 212 into the outflow 224, so that, when the front flap 220 is opened, the working environment is polluted only insignificantly. It may be pointed out, however, that the supply line 328 and the exhaust air line 332 are in each case optional components, and that the basin washer 310 could also be implemented in each case without these components or in each case with only one of these components.

Furthermore, the basin washer 310 according to the invention again comprises a microwave disinfection apparatus 160 in the exemplary embodiment illustrated in FIG. 3. This microwave disinfection apparatus 160 is configured, for example, similarly to the microwave disinfection apparatuses 160 according to the abovementioned exemplary embodiments, and therefore reference may be made to the above descriptions and disinfection principles. Once again, the microwave disinfection apparatus 160 comprises a waveguide 168 which issues in the washing chamber 212 and via which the cleaning stock 112 can be subjected to microwave radiation 172. Similarly to the example in FIG. 2, in the exemplary embodiment illustrated in FIG. 3, too, the microwave disinfection apparatus 160 preferably has, at the issue of the waveguide 168 into the washing chamber 212, a self-closing valve which again may be configured, for example, in the form of a flap 238. This flap 238 not only prevents moisture from penetrating into the waveguide 168, but may also cause the washing chamber 212 to be leak-tight during a displacement of steam out of the washing chamber 212. Thus, when fresh air is pressed in via the supply line 328 (for example, via a blower, not illustrated), the flap 238 can be closed by means of a slight overpressure in the washing chamber 212, so that moist exhaust air and steam can be displaced into the outflow 224 via the exhaust air line 332, the flap 238 at least largely preventing this moist air and this steam from being displaced toward the microwave source or the magnetron 164. The nonreturn valve 334 prevents a recontamination of the inner space of the washing chamber 212 and of the washing stock 112 received in it.

Subsequently, for example after the steam displacement step described, the microwave disinfection apparatus 160 can be started (for example, once again, via a control 176 which controls the program sequence correspondingly), so that the washing stock 112 is subjected to microwave radiation 172 and is therefore disinfected directly or indirectly in addition to the steam disinfection step. Once again, in this case, the blower 162 of the microwave disinfection apparatus 160 can generate, inside the washing chamber 212, an air stream which assists the drying of the cleaning stock 112. A discharge of overpressure which is generated by the blower 162 of the microwave disinfection apparatus 160 can take place into the outflow 224 via the exhaust air line 332.

Alternatively or additionally, the microwave disinfection apparatus 160 may also assist the steam disinfection step described above or even replace it entirely. If the steam disinfection step is assisted, for example, the principle of heating the cleaning stock 112, direct germ killing by microwave radiation 172, steam superheating, heating adhering water or a combination of these and/or of other principles may be employed. A program sequence may therefore provide an emptying (optional) of the washing stock, fluid cleaning, a steam disinfection step (optional) and a microwave disinfection step, and also, again optionally, a drying and/or cooling step, for example with a steam displacement step. Individual program steps can also be carried out repeatedly, and the order illustrated is preferred, but is not mandatory. A program sequence of this type may then be controlled, for example by means of the control 176. If the cleaning appliance is configured as a basin washer 310, the configuration described above, in which one or more target pathogens, with which disinfection can be coordinated in a directed manner, is predetermined by a user (for example, by direct input and/or by data transfer) in the control 176 via the interface 177, is one which, in particular, has positive effects.

A further advantage of the microwave disinfection in the exemplary embodiment illustrated in FIG. 3 and also in other types of cleaning appliances is that the microwave disinfection can also assist a drying of the cleaning stock 112. Once again, in the exemplary embodiment illustrated in FIG. 3, too, microwave disinfection and/or drying, for example microwave drying or “conventional” drying, can be monitored via a temperature sensor 174, again indicated merely symbolically in FIG. 3, and, for example, controlled by the control 176.

Moreover, FIG. 3 illustrates a further exemplary embodiment, showing how microwave radiation 172 can be used for steam generation and therefore for steam sterilization. This type of steam generation can be employed alternatively or additionally to the above-described steam generators or types of steam generation.

For this purpose, according to the exemplary embodiment illustrated in FIG. 3, the basin washer 310 comprises, in the region of the siphon bend 226 of the outflow 224, a further microwave disinfection apparatus 116 which again comprises a magnetron 164, a blower 162 and a waveguide 168. Through a microwave-transparent window 336 which prevents water from penetrating from the siphon bend 226 into the waveguide 168, microwave radiation 172 can be used in order to heat water in the siphon bend 226 so that steam results. This steam may, in turn, contribute to the sterilization action. Accordingly, this type of steam generation may be incorporated into the above-described method sequences in one or more variants. Moreover, the heating of the water supply in the siphon bend 226 may also be used to disinfect this water supply, thus preventing recontamination of the cleaning stock 112 in the washing chamber 212 and reducing the formation of odors.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cleaning appliance for cleaning of cleaning stock, the cleaning appliance comprising:
a cleaning zone configured to clean the cleaning stock with a cleaning fluid;
a microwave disinfection apparatus having a microwave source configured to generate microwave radiation, the microwave disinfection apparatus being configured to bring about a hygienization of the cleaning stock received in the cleaning appliance;
a basin washer configured to clean medical instruments and/or care instruments, in which large quantities of liquid waste and/or solid waste to be disposed of occur, the basin washer having an outflow with a siphon bend; and
a washing chamber configured to subject the cleaning stock in the washing chamber to the cleaning fluid,
wherein the microwave disinfection apparatus is configured to at least partially hygienize the cleaning stock in the washing chamber.

2. The cleaning appliance as claimed in claim 1, wherein the microwave disinfection apparatus is configured to carry out at least one of the following germ reduction processes:
via microwave radiation, steam is generated in a steam generator of the microwave disinfection apparatus, the steam being used in order to carry out germ reduction;
the microwave radiation is aligned with the cleaning stock, the microwave radiation being configured to heat the cleaning stock;
the microwave radiation is aligned with the cleaning stock, the microwave radiation being configured to reduce germs on and/or in the cleaning stock and/or in the cleaning appliance;
the microwave radiation is aligned with the cleaning stock, the microwave radiation being configured to heat the cleaning fluid adhering to the cleaning stock; and/or
the cleaning appliance being configured to subject the cleaning stock to steam generated by a steam generator, the microwave disinfection apparatus being configured to superheat the steam by microwave radiation.

3. The cleaning appliance as claimed in claim 1, wherein the microwave disinfection apparatus further comprises a magnetron.

4. The cleaning appliance as claimed in claim 1, wherein the microwave disinfection apparatus has at least one waveguide for orienting the microwave radiation.

5. The cleaning appliance as claimed in claim 4, wherein the waveguide has a closable orifice or an opening flap inside the cleaning zone.

6. The cleaning appliance as claimed in claim 1, wherein the microwave disinfection apparatus is configured to apply hot air to the cleaning stock.

7. The cleaning appliance as claimed in claim 1, wherein the microwave disinfection apparatus is configured to subject the cleaning stock to microwaves with at least two frequencies.

8. The cleaning appliance as claimed in claim 1, wherein the microwave disinfection apparatus is configured to emit microwave radiation with at least one frequency which is absorbed at least partially by the cleaning stock.

9. The cleaning appliance as claimed in claim 1, wherein the microwave disinfection apparatus is configured to emit microwave radiation with at least one frequency which is absorbed at least partially by the cleaning fluid adhering to the cleaning stock.

10. The cleaning appliance as claimed in claim 1, wherein the microwave disinfection apparatus is configured to emit microwave radiation with at least one frequency which is absorbed at least partially by germs adhering to the cleaning stock.

11. The cleaning appliance as claimed in claim 1, wherein the microwave disinfection apparatus is configured to emit microwave radiation with at least one frequency which is absorbed at least partially by steam contained in the cleaning appliance.

12. The cleaning appliance as claimed in claim 1, wherein the microwave disinfection apparatus is configured to emit microwaves in a frequency band and is configured to vary the frequency band in time so that the frequency band successively covers different frequency ranges.

13. The cleaning appliance as claimed in claim 1, wherein the cleaning appliance has at least one temperature sensor for detecting the temperature of the cleaning stock.

14. The cleaning appliance as claimed in claim 13, wherein the temperature sensor has at least one infrared sensor.

15. The cleaning appliance as claimed in claim 1, wherein the microwave disinfection apparatus further comprises at least one blower, the blower being configured to assist drying of the cleaning stock by an air stream.

16. The cleaning appliance as claimed in claim 1, wherein the cleaning appliance has a heat recovery device and/or a steam precipitation device.

17. The cleaning appliance as claimed in claim 1, wherein the cleaning appliance is configured to enable a user to input at least one target germ and/or one group of target germs, and wherein the cleaning appliance is configured to activate the microwave disinfection apparatus according to this selection.

18. The cleaning appliance as claimed in claim 17, wherein the cleaning appliance has a control component that is configured to control the microwave disinfection apparatus according to the selected target germ and/or the group of target germs.

19. The cleaning appliance as claimed in claim 18, wherein the control component transmits at least one control signal with at least one of the following information items to the microwave disinfection apparatus:
a target germ-specific frequency or a target germ-specific frequency band;
a target germ-specific action time of a disinfection; and/or
a target germ-specific active dose.

20. The cleaning appliance as claimed in claim 1, wherein the cleaning appliance further comprises a control component for a control of a program sequence, at least one program step of a program sequence being configured as a germ reduction step.

21. The cleaning appliance as claimed in claim 1, wherein the microwave disinfection apparatus has a blower, the basin washer has an outflow with a siphon bend and an exhaust air line which, bypassing the siphon bend, issues from the washing chamber into the outflow, and wherein the blower is configured to displace moist air out of the washing chamber into the outflow.

22. The cleaning appliance as claimed in claim 21, wherein the exhaust air line has a self-closing valve or a nonreturn valve.

23. The cleaning appliance as claimed in claim 1, wherein the basin washer has an outflow, and wherein the microwave disinfection apparatus is configured to heat fluid received in the outflow.

24. The cleaning appliance as claimed in claim 23, wherein the microwave disinfection apparatus is configured to generate steam from fluid received in the outflow and to at least partially hygienize cleaning stock in the washing chamber via the steam.

25. A method for the cleaning of cleaning stock in a cleaning appliance, the method comprising:
cleaning the cleaning stock with a cleaning fluid in at least one cleaning zone of the cleaning appliance; and
partially hygienizing the cleaning stock via a microwave disinfection apparatus,
wherein the cleaning appliance has a basin washer configured to clean medical instruments and/or care instruments in which large quantities of liquid waste and/or solid waste to be disposed of occur, the basin washer having an outflow with a siphon bend, the cleaning zone comprising a washing chamber,
wherein the basin washer is configured to subject cleaning stock in the washing chamber to the cleaning fluid, and
wherein the microwave disinfection apparatus at least partially hygienizes the cleaning stock in the washing chamber.
